(19) United States
(12) Patent Application Publication
(10) Pub. No.: US 2015/0090743 A1
(43) Pub. Date: Apr. 2, 2015

(54) Container Closure For Vented Pouring Through A Curved Aperture

(71) Applicant: APTAR-GROUP, INC, Crystal Lake, IL (US)

(72) Inventors: John M. Wisniewski, Wauwatosa, WI (US); Christopher A. Danks, Waukesha, WI (US)

(73) Assignee: AptarGroup, Inc., Crystal Lake, IL (US)

(21) Appl. No.: 14/381,434

(22) PCT Filed: May 2, 2012
(86) PCT No.: PCT/US12/36043

§ 371 Date: Aug. 27, 2014

(51) Int. Cl. B65D 47/08; B65D 51/16; B67D 3/00

(52) U.S. Cl. CPC B65D 47/08; B67D 3/0051; B65D 51/1611
USPC 222/478; 222/567; 220/837; 220/373

(57) ABSTRACT

A closure (20, 20A) is provided for a container that has an opening to the container interior wherein contents may be stored. The closure (20, 20A) includes the following: (A) a closure body (30, 30A) defining (i) at least one pour aperture (50) that can communicate with the container opening and that can accommodate pouring out of the contents through the pour aperture (50), and (ii) at least one vent aperture (60) that can. communicate with the container opening and that can accommodate the in-venting of ambient atmosphere through the vent aperture into the container; and (B) a lid (32, 32A) for closing the closure (20, 20A). The pour aperture (50) has a curved configuration extending laterally on each side of a central axis line (A) that bisects the closure body (30), and the vent aperture (60) is further defined by a downwardly extending vent tube.

### TECHNICAL FIELD

This invention relates to container closures.

### BACKGROUND OF THE INVENTION AND TECHNICAL PROBLEMS POSED BY THE PRIOR ART

Various flowable substances (including liquids) may be packaged in a rigid, flexible, or collapsible container (e.g., bottle, pouch, etc.) having a closure that can be opened to allow the contents to be poured out. The container with the closure mounted thereon and the contents stored therein may be characterized as a “package.”

The inventors of the present invention have invented a novel structure for a container closure wherein the closure includes advantageous features not heretofore taught or contemplated by the prior art.

### SUMMARY OF THE INVENTION

According to broad aspects of one form of the invention, a closure is provided for a container that has an opening to the container interior wherein contents may be stored. The closure includes a body that is either (a) a separate structure for being attached to the container at the opening, or (b) a structure formed as a unitary portion of the container at the opening.

The closure body has a deck defining (i) at least one pour aperture that can communicate with the container opening and that can accommodate pouring out of the contents through the at least one pour aperture wherein the pour aperture has a curved configuration extending laterally on each side of a central axis line (A) that bisects the closure body, and (ii) at least one vent aperture that can communicate with the container opening and that can accommodate the in-venting of ambient atmosphere through the at least one vent aperture into the container.

The closure body has a spout projecting outwardly from the deck and extending at least partway around the at least one pour aperture.

The closure also includes a lid for accommodating movement relative to the closure body between (a) a closed position sealing against the closure body to prevent flow of the contents outwardly of the closure body, and (b) an open position permitting flow of the contents outwardly of the closure body.

The closure is characterized in that the at least one vent aperture (i) has a cross-sectional flow area as measured at the deck; and (ii) is further defined by a vent tube which projects downwardly from the deck to define a vent path length from the top of the vent aperture to the bottom of vent tube wherein the ratio of the path length to the cross-sectional flow area is between about 1 and 2.

The closure can be provided with a design that accommodates efficient, high quality, large volume manufacturing techniques with a reduced product reject rate.

The closure can optionally be designed to accommodate its use with a variety of conventional or special containers having a variety of conventional or special, container finishes (e.g., snap-fit attachment configurations, thermal bonding configurations. etc.).

Numerous other advantages and features of the present invention will become readily apparent from the following detailed description of the invention, from the claims, and from the accompanying drawings.

### BRIEF DESCRIPTION OF THE DRAWINGS

In the accompanying drawings forming part of the specification, in which like numerals are employed to designate like parts throughout the same,

FIG. 1 is an isometric view, taken from the front and right side, of a first embodiment of a closure of the present invention with the closure in the closed condition (prior to installation on a container (not shown) filled with contents to define a package);

FIG. 2 is an isometric view of the first embodiment of the closed closure from the rear and left side;

FIG. 3 is a top plan view of the first embodiment of the closed closure;

FIG. 4 is a front elevation view of the first embodiment of the closed closure;

FIG. 5 is a right side elevational view of the first embodiment of the closed closure, the left side elevational view thereof being a mirror image;

FIG. 6 is a rear elevational view of the first embodiment of the closed closure;

FIG. 7 is a bottom view of the first embodiment of the closed closure taken along the view line 7-7 in FIG. 6;

FIG. 8 is an isometric view from the upper, right front corner of the first embodiment of the closure shown in FIG. 1, but in FIG. 8 the lid is open;

FIG. 9 is an isometric view from the upper, left rear corner of the first embodiment of the closure shown in FIG. 2, but in FIG. 9 the lid is open;

FIG. 10 is a top plan view of the first embodiment of the closure shown in the fully opened condition;

FIG. 11 is a cross-sectional view taken generally along the plane 11-11 in FIG. 10;

FIG. 12 is a side elevation view of the opened closure shown in FIG. 10;

FIG. 13 is a bottom plan view of the opened closure shown in FIG. 13; and

FIG. 14 is an isometric view, taken from the front and right side, of a second embodiment of the closure of the present invention shown in the closed condition.

### DESCRIPTION OF THE PREFERRED EMBODIMENTS

While this invention is susceptible of embodiment in many different forms, this specification and the accompanying drawings disclose only some specific forms as examples of the invention. The invention is not intended to be limited to the embodiments so described, however. The scope of the invention is pointed out in the appended claims.

For ease of description, many of the figures illustrating the invention show the embodiments of the closure of this invention in the typical orientation that the closure would have at the top of a container (not shown) when the container is oriented upright, and terms such as upper, lower, horizontal, etc., are used with reference to this orientation. It will be understood, however, that the closure of this invention may be manufactured, stored, transported, used, and sold in an orientation other than the orientations described.

The closure of this invention is suitable for use with a variety of conventional or special containers, the details of which, although not fully illustrated or described, would be apparent to those having skill in the art and an understanding of such containers. The particular containers, per se, that are illustrated and described herein form no part of, and therefore are not intended to limit, the present invention. It will also be understood by those of ordinary skill that novel and non-obvious inventive aspects are embodied in the described exemplary closures alone.

The closure will typically be used on a container that contains a flowable product (e.g., a liquid, cream, slurry, etc.) in the form of a fluent substance that can be poured from the container through the opened closure. Such a fluent substance may be sold, for example, as a food product (e.g., soy sauce), a personal care product, an industrial product, a household product, or other types of products. Such substances may be for internal or external use by humans or animals, or for other uses (e.g., activities involving medicine, manufacturing, commercial or household maintenance, construction, agriculture, etc.).

A first embodiment of a closure of the present invention is illustrated in the Figures wherein the closure is designated generally by reference number 20. In the illustrated first embodiment, the closure 20 is provided in the form of a separate closure 20 which is adapted to be mounted on, or otherwise attached to, a container (not shown) that would typically contain contents such as a product consisting of a fluent substance. The container typically has a top portion extending upwardly to define an opening to the container interior and may be formed from a material suitable for the intended application (e.g., molded polyethylene or polypropylene).

It is contemplated that typically, after the closure manufacturer makes the closure 20 (e.g., by molding the closure 20 from a thermoplastic polymer), the closure manufacturer will then ship the closure 20 to a container filler facility at another location where the container is either manufactured or otherwise provided, and where the container is filled with a product prior to installation of the closure 20 on the filled container.

In the illustrated embodiments, the closure is provided as a separately manufactured article, component, or unit for being removably or non-removably attached (e.g., mounted or installed) on a container. Further, it may be desirable for the closure (or at least a base portion of the closure) to be formed as a unitary part, or extension, of the container wherein such a unitary part or extension may also be characterized as simultaneously defining an end structure of the container, per se.

The illustrated preferred embodiments of the closures are initially formed separately from the container, and are adapted to be attached to the container at an opening which provides access to the container interior and to the contents (e.g., a product contained therein) after a portion of the closure is opened.

The container, per se, does not form a part of the broadest aspects of the closure of the present invention, per se. The container may have any suitable configuration. With those forms of the closure of the present invention wherein the closure is a separately formed article, the container typically includes an, upper end portion (or other suitable structure on some part of the container) that defines the container mouth or opening, and such a container opening portion or structure has a cross-sectional configuration with which the closure is adapted to engage. The main body portion of the container may have another cross-sectional configuration that differs from the cross-sectional configuration of the container at the container opening. On the other hand, the container may instead have a substantially uniform shape along its entire length or height without any portion of reduced size or different cross-section.

The container may have a generally rigid wall or walls which can be grasped by the user. The illustrated embodiments of the closure are also suitable for use with a container having a flexible wall or walls.

As seen in FIG. 8, the first embodiment of the closure 20 includes (A) a body 30 (which may be characterized as defining a peripheral wall, base, or other analogous structure intended to be located at the top of the container), (B) a lid 32 (i.e., cap or cover), and (C) a hinge 36 joining the lid 32 to the body 30. In the illustrated, preferred first embodiment of the closure 20, the closure body 30, lid 32, and hinge 36 are molded together as a unitary structure from a suitable thermoplastic material such as polypropylene or the like. Other materials may be employed instead. In the illustrated embodiment, the closure 20 is initially molded as a completely separate article that is subsequently attached to the container (not shown) after the container has been initially filled with a product.

In alternate designs (not illustrated), the closure 20 could be made from a plurality of separate parts that are assembled together.

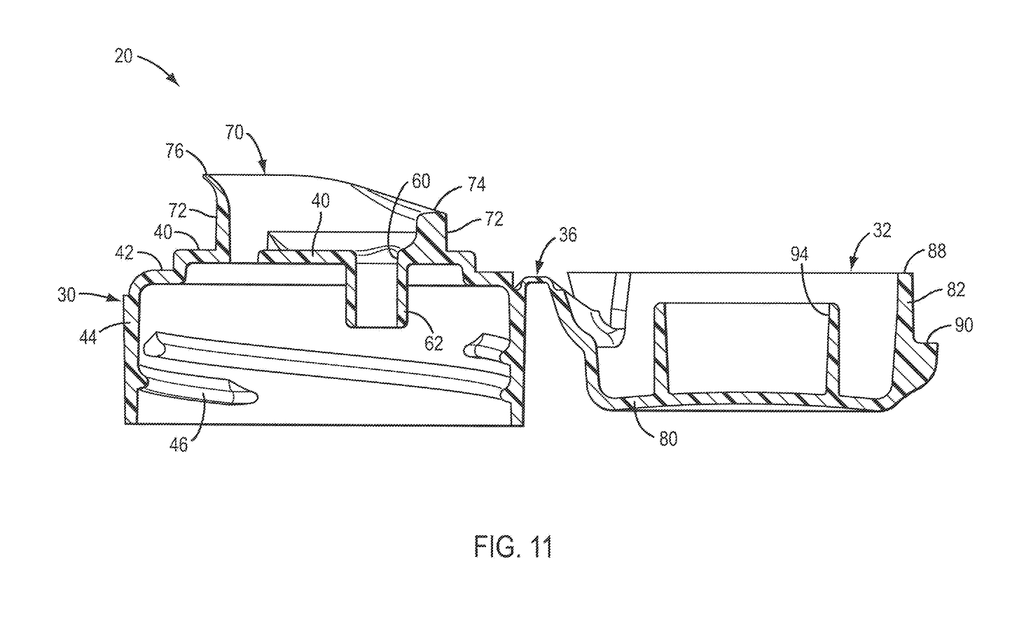

As can be seen in FIG. 11, the closure body 30 includes an upper deck which can also be characterized as an inner deck 40. As can be seen in FIG. 11, the body 30 has a lower, outer deck 42 which extends outwardly relative to the inner deck 40. In a preferred embodiment, the outer deck 42 extends from the periphery of the inner deck 40.

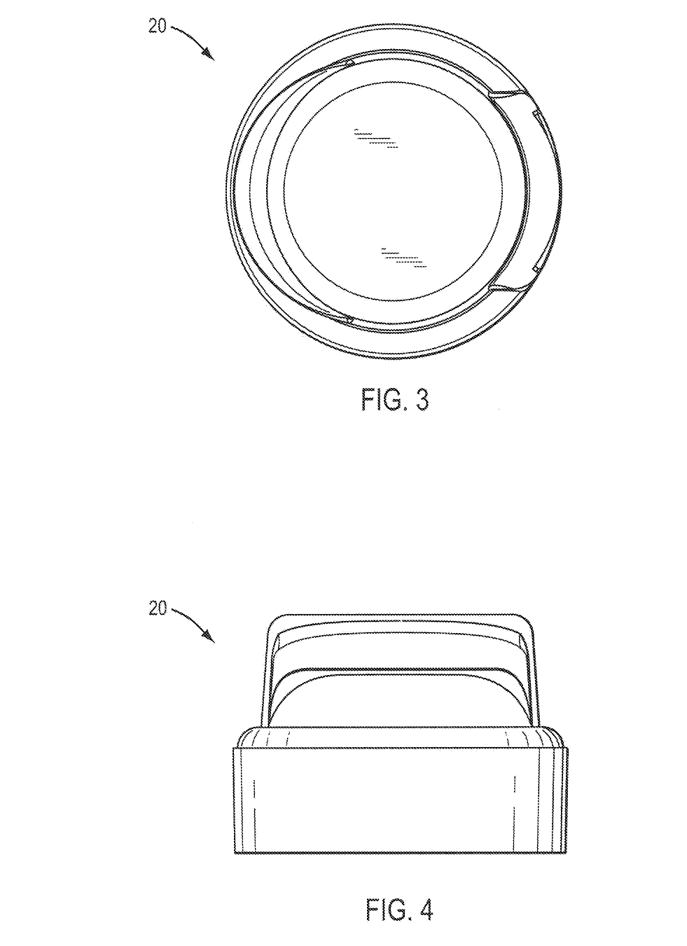

Extending downwardly from the periphery of the outer deck 42 is a skirt 44 for engaging the container (not shown) when the closure body 30 is mounted on the container. As can also be seen in FIG. 3, the skirt 44 of the closure body 30 defines an internal, female thread 46 for threadingly engaging a mating external, male thread (not shown) on the container (not shown) when the dispensing closure body 30 is installed on the container.

Alternatively, the closure body skirt 44 could be provided with some other container connecting means, such as a snap-fit bead or groove (not illustrated) for engaging a container neck groove or bead (not illustrated), respectively. The main part of the container may have a different cross-sectional shape than the container neck and closure body skirt 44. The closure body skirt 44 may have any suitable configuration for accommodating an upwardly projecting neck of the container (not shown) or for accommodating any other portion of a container received within the particular configuration of the closure body 30—even if a container does not have a neck, per se.

Also, the closure body skirt 44 could instead be permanently attached to the container by means of induction melting and bonding, ultrasonic melting and bonding, gluing, or the like, depending on materials used for the closure body skirt 44 and container. In another alternate design (not illustrated), the closure body skirt 44 could be formed (e.g., molded) as a unitary extension, or part, of the container.

In the illustrated first embodiment of the invention, the container-receiving opening defined by the closure body skirt 44 has a generally cylindrical configuration and includes the thread 46 that projects laterally inwardly. However, the closure, body skirt 44 may have other configurations. For example, the closure body skirt 44 might have a prism or polygon configuration adapted to be mounted to the top of a container neck having a polygon configuration. Such prism or polygon configurations might not accommodate a threaded attachment, but other means of attachment could be provided, such as a snap-fit bead and groove arrangement, adhesive, or the like.

As can be seen in FIG. 11, the underside of the outer deck 42 is flat. However, if desired, the underside of the outer deck 42 could be provided with a conventional, flexible, “crab's claw” configuration seal (not shown) that would project downwardly from the underside of the outer deck 42 to seal against the annular top surface of the container. Other conventional or special seal features could instead be provided to extend downwardly from the underside of the closure body outer deck 42. Such a seal could be a conventional “V” seal, or some other conventional or special seal, depending upon the particular application.

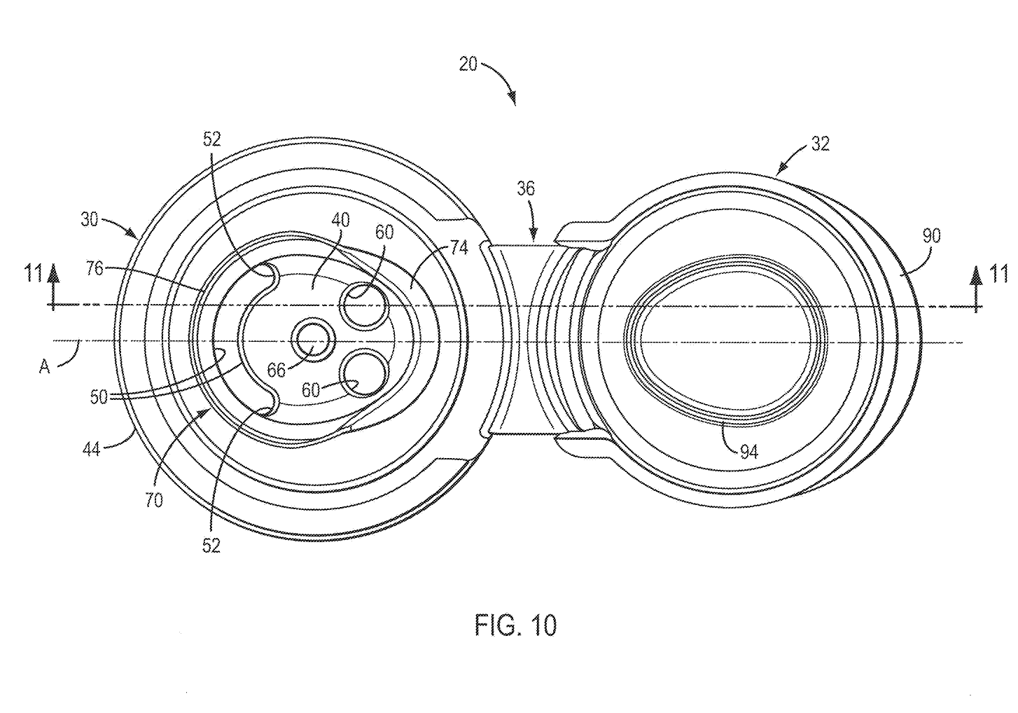

As can be seen in FIG. 10, the closure body inner deck 40 defines a curved configuration pour orifice or aperture 50. In the preferred embodiment illustrated in FIG. 10, the aperture 50 is arc-shaped and has a generally constant width and arcuate ends 52. Preferably, the closure body skirt 44 is cylindrical, and the pour aperture 50 is defined in part by two concentric circular arcs which, in the preferred embodiment, are concentric with the cylindrical closure body. In the preferred embodiment illustrated, the pour aperture 50 extends laterally and equidistantly on each side of a central axis line A (FIG. 11) that bisects the closure body 30 (and also the hinge 36 and lid 32 in the illustrated preferred embodiment).

As can be seen in FIG. 10, the closure body deck 40 also defines at least one vent aperture 60. Preferably, there are two spaced-apart vent apertures 60. In the illustrated, preferred, first embodiment, the vent apertures 60 are circular and have identical diameters.

As can be seen in FIG. 11, below the inner deck 40, in the preferred embodiment each vent aperture 60 is further defined by a downwardly extending vent tube 62 which is preferably cylindrical and which projects downwardly from the underside of the inner deck 40. When the closure 20 is closed and installed on a container (not illustrated), the bottom of each vent tube 62 is received within the container opening and projects downwardly somewhat below the top of the container which is sealed against the underside of the closure body outer deck 42.

As can be seen in FIG. 10, each aperture 60 (which, in the illustrated preferred embodiment is defined in part by its associated, corresponding vent tube 62) is spaced from the closure body central axis line A. More particularly, in the preferred embodiment illustrated in FIG. 10, the two circular vent apertures 60 which have the same diameter are (1) spaced equidistantly from, and are on opposite sides of, the closure body central axis line A, and (2) located with the centers of the vent apertures 60 on a straight line that is perpendicular to the closure body central axis line A. The vent apertures 60 are preferably spaced apart by a distance that is less than the diameter of the vent apertures 60.

As can be seen in FIG. 10, the pour aperture 50 preferably extends laterally on each side of the closure body central axis line A to a location that is further away from the closure body central axis line A than is any part of each vent aperture 60.

Further, in the preferred embodiment illustrated in FIG. 10, the diameter of each vent aperture 60 is uniform along the length of the vent aperture 60 (including along the vertical length or height of the cylindrical interior of the downwardly projecting vent tube 62), and the diameter is greater than the width of the pour aperture 50 (as the width of the pour aperture 50 is measured along the closure body central axis line A).

Further, in the preferred embodiment illustrated in FIG. 10, each vent aperture 60 is spaced away from the nearest portion of the pour aperture 50 by an amount that is greater than the vent aperture diameter.

As can be seen in FIG. 11, the distance that each vent tube 62 preferably extends below the underside of the inner deck 40 is greater than the vent aperture diameter.

In the preferred embodiment illustrated in FIG. 10, the distance that the pour aperture 50 extends beyond the closure body central axis line A is greater than the width of the pour aperture 50 (as the width of the pour aperture 50 width is measured along the closure body central axis line A). The length of the pour aperture 50 is greater than its greatest width as the width is measured on or parallel to the central axis line A.

In the preferred embodiment illustrated in FIG. 10, the pour aperture 50 extends in opposite directions from the closure body central axis A along a circular arc that is greater than 90 degrees in total arc length (as measured from one end 52 of the pour aperture 50 on one side of the closure body central axis line A to the other end 52 of the pour aperture 50 on the other side of the closure body central axis line A).

As can be seen in FIGS. 8 and 9, in the preferred embodiment a small, circular formation 66 projects upwardly slightly from the upper surface of the inner deck 40 at the center of the closure body 30. When the opened closure 20 is viewed from above along the closure central axis line A looking from the front toward the hinge 36, the circular formation 66 may be characterized as a “nose” of a “smiley face” wherein the eyes of the face are defined by the two vent apertures 60 and wherein an open mouth is defined by the pour aperture 50.

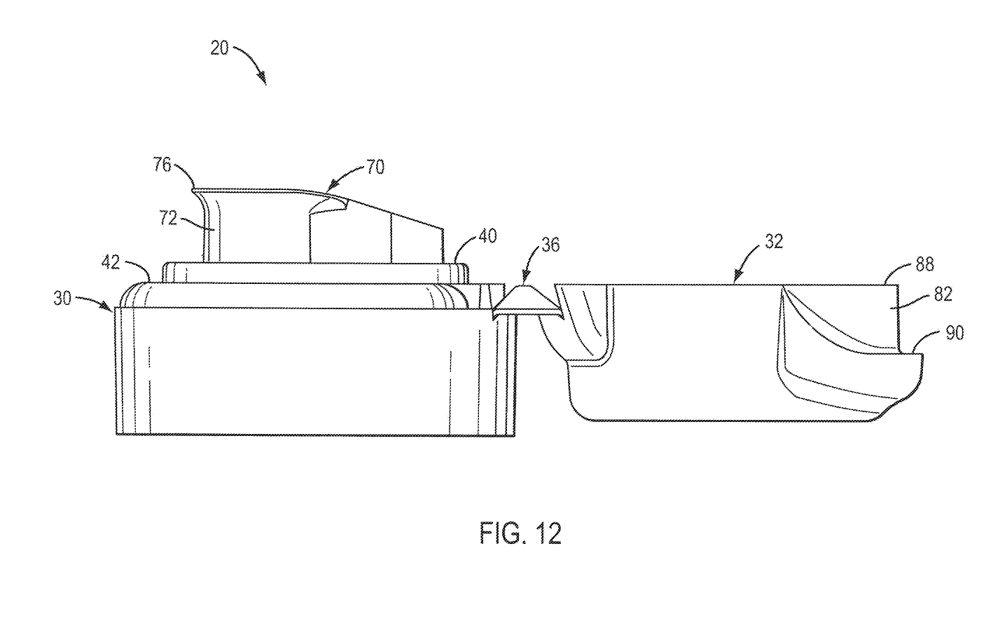

As can be seen in FIG. 8, a pour spout 70 extends at least partway around the pour aperture 50. In the preferred embodiment illustrated, the pour spout 70 extends completely around the pour aperture 50 and the two vent apertures 60. As can be seen in FIG. 12, the pour spout 70 includes a generally vertically oriented lower portion 72. At the rear of the closure body 30 adjacent the hinge 36, the spout lower portion 72 defines an upwardly facing surface 74 (FIGS. 9 and 11). At the front of the spout 70, a pour lip 76 flares outwardly from the top of the lower portion 72. In plan view, the spout 70 defines a somewhat oval or egg-shaped profile (FIG. 10).

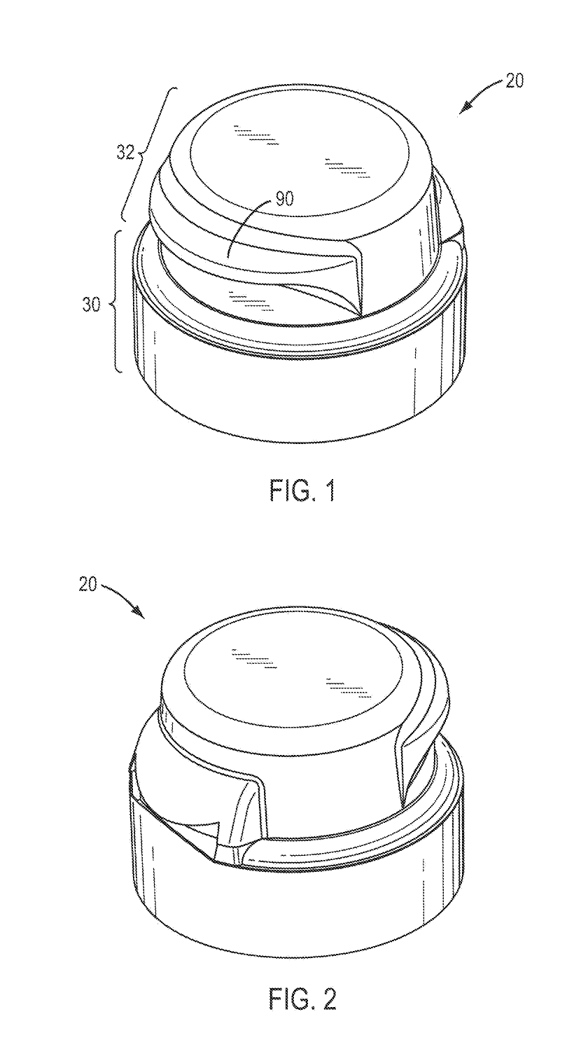

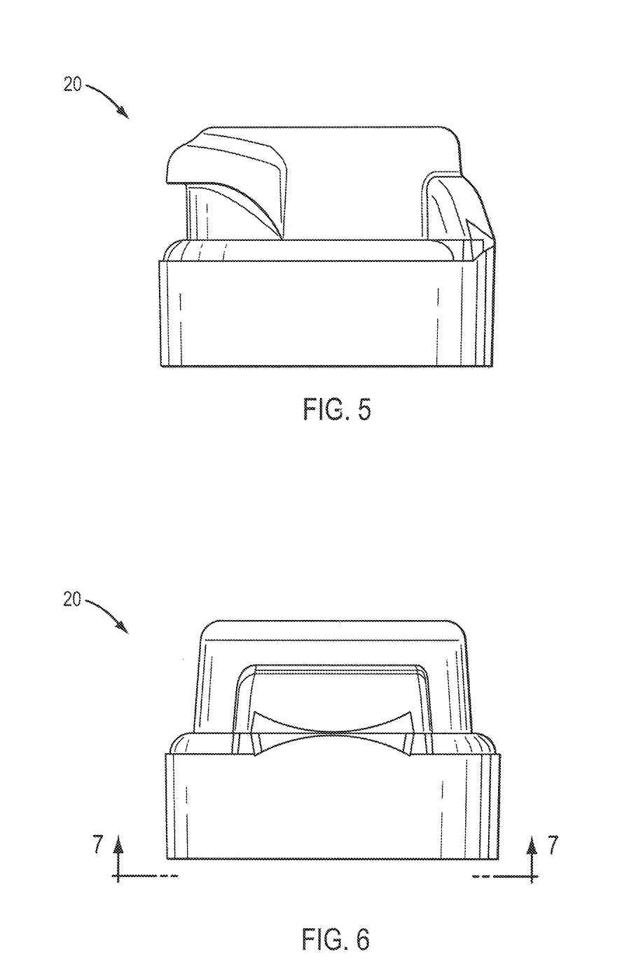

In the preferred form of the invention, the lid 32 is provided to be closed over, and to cover, an upper part of the closure body 30. The lid 32 can be moved to expose the upper part of the closure body 30 to permit pouring out of the contents (i.e., product) through the pour aperture 50 from the container. The lid 32 is movable between (1) a closed position over the body 30 (as shown in FIGS. 1-6) sealing against the closure body 30 to prevent flow of the contents (i.e., product) outwardly of the closure body 30, and (2) an open position (as shown in FIGS. 8-11). In the preferred embodiment illustrated, the lid 32 is hinged to the closure body 30 by means of the hinge 36 so as to accommodate pivoting movement of the lid 32 between the closed position and the open position wherein the lid 32 pivots on a hinge pivot axis that is perpendicular to the closure body central axis line A.

As seen in FIG. 11, the lid 32 includes a top end wall or cover 80 substantially surrounded by a peripheral lid flange 82. As seen in FIGS. 8, 11, and 12, the lid flange 82 has an end surface 88 for being received on, and abutting, the closure body outer deck. 42 when the lid 32 is closed (FIG. 1).

In the illustrated embodiment, the closure hinge 36 is molded unitary with the lid flange 82 and with the closure body 30 so as to accommodate movement of the lid 32 between the open position exposing the closure spout 70, and the closed position sealing against the inside surface of the closure spout 70. The hinge 36 may be of any suitable conventional or special design. The hinge 36 may be a conventional snap-action type such as described in the U.S. Pat. No. 5,356,017, U.S. Pat. No. 5,642,824, or U.S. Pat. No. 6,321,923. The hinge could also be a non-snap-action type hinge, including a strap or tether. In yet other embodiments, the hinge could be a conventional two-piece hinge, such as a clip hinge (e.g., wherein an axle could be provided on the lid 32 while a socket to receive that axle could be provided on the closure body 30). In some applications, the hinge (or any connection between the body 30 and lid 32) maybe omitted altogether.

A finger tab or thumb tab 90 (FIGS. 1, 9, and 11) may optionally be provided to project laterally outwardly at the front of the closure lid flange 82 to assist in lifting the lid 32 to the open position.

The lid 32 preferably also includes a hollow spud 94 (FIGS. 8, 9, and 11) for entering into the spout 70 of the closure body 30 when the lid 32 is closed. The spud 94 extends from lid end wall 80. In the preferred embodiment, the closure body spout 70 and the spud 94 each has a configuration for accommodating mating engagement when the lid 32 is closed, such as via sealing engagement of the spud 94 with the inside surface of the spout 70.

The configuration of the spout 70 facilitates the pouring of a fluent product (i.e., contents) from the container when the lid 32 is opened. When the lid 32 is closed, the spud 94 acts to contain the movement of the fluent product (i.e., contents) within the inside of the spout 70 so as to mitigate undesired movement of fluent product about the underside of the lid 32, and so as to prevent flow of the fluent product outwardly of the closure body spout 70 into the region between the exterior of the spout 70 and the lid flange 82.

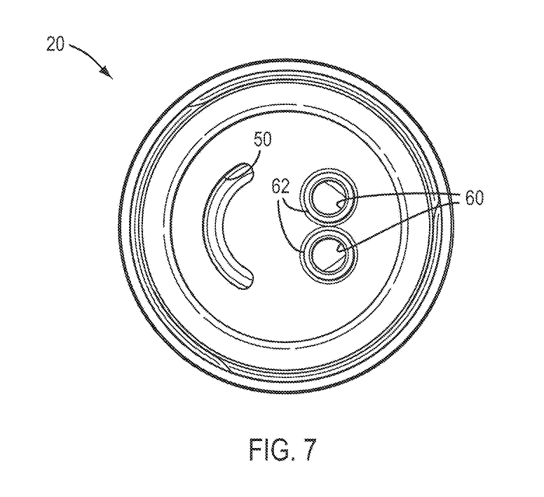

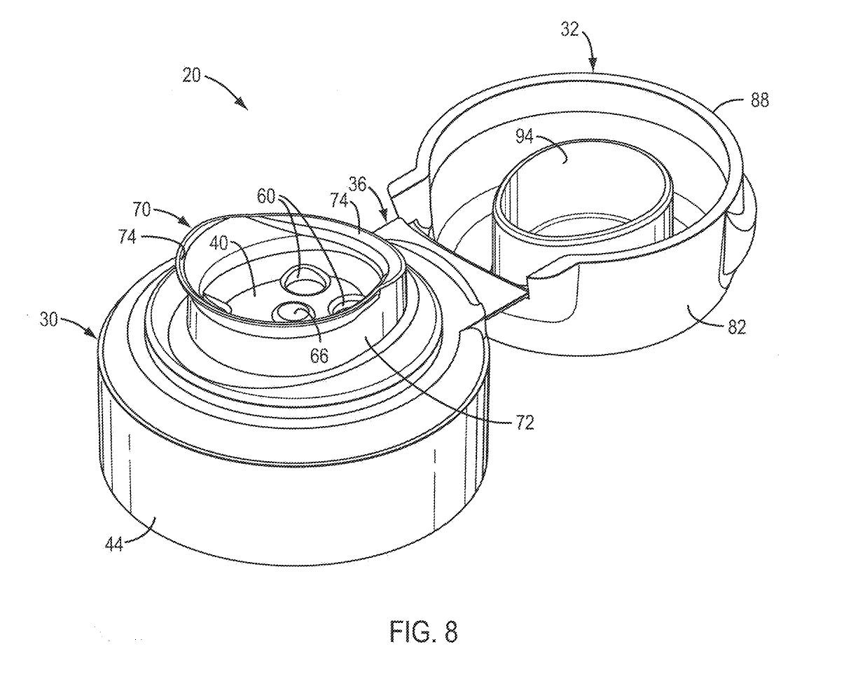

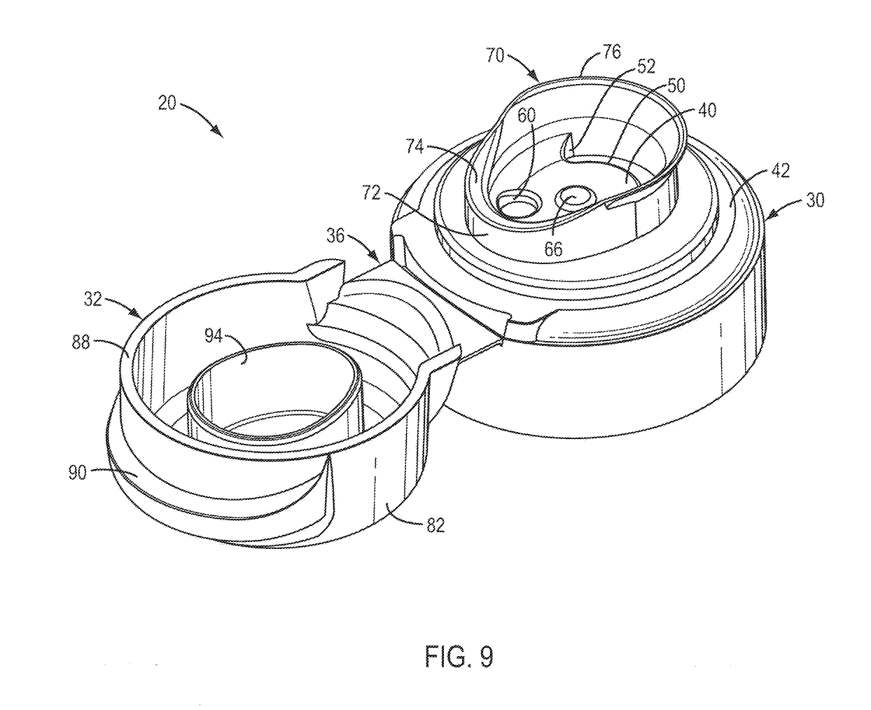

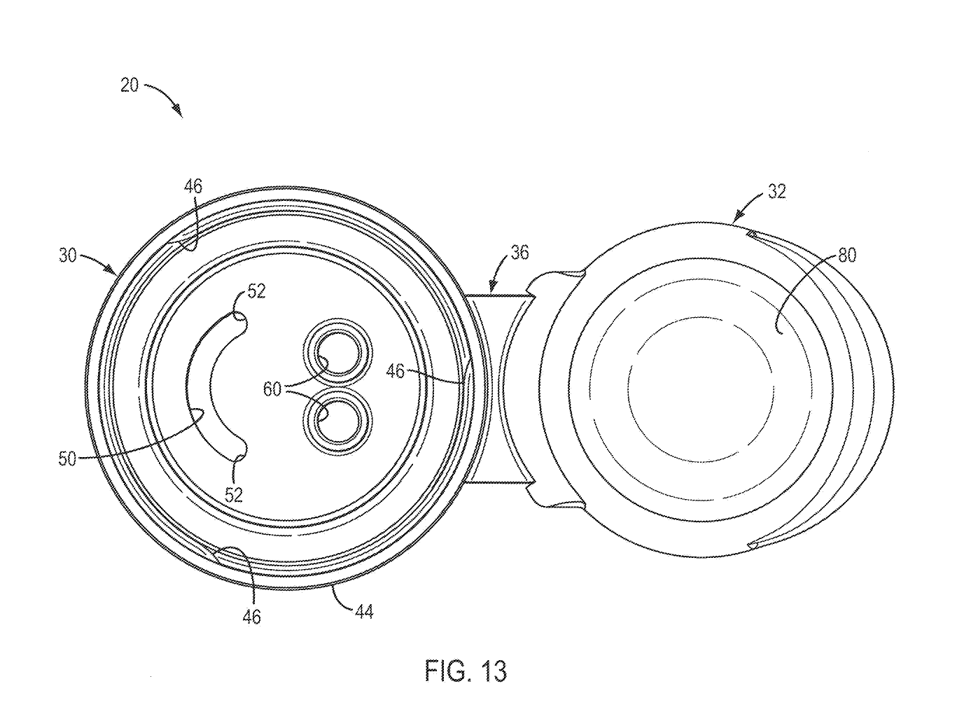

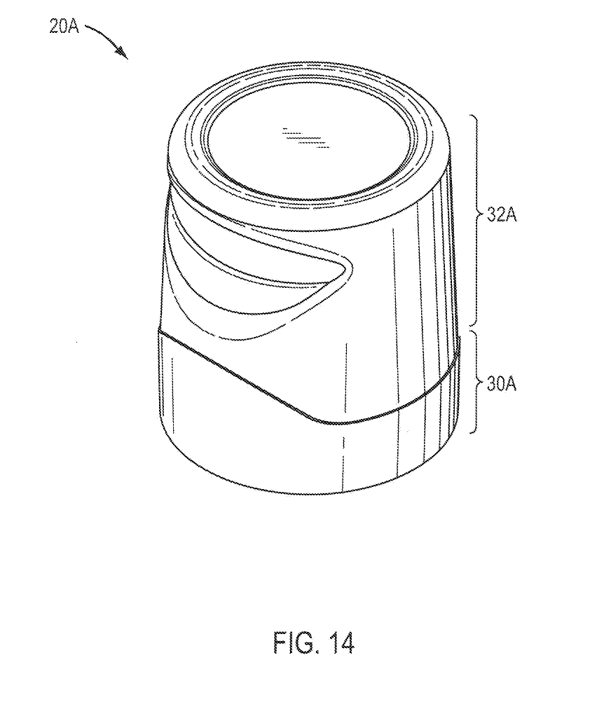

FIG. 14 shows a second embodiment of a closure of the present invention wherein the second embodiment of the closure is designated generally by the reference number 20A. The second embodiment of the closure 20A is generally similar to the first embodiment of the closure 20 discussed above with reference to FIGS. 1-13. The second embodiment of the closure 20A shown in FIG. 14 differs from the first embodiment of the closure 20 in that the second embodiment of the closure 20A has a taller configuration. In particular, the closure 20A includes a lid 32A which is much taller than the lid 32 of the first embodiment of the closure 20 described above with reference to FIGS. 1-13, but the taller lid 32A is still adapted to close and open relative to a base or body 30A. This configuration of the closure 20A provides a completely different aesthetic exterior design of the closed closure compared to the aesthetic design of the first embodiment of the closed closure 20 described above with reference to FIGS. 1-13. The internal configuration of the second embodiment of the closure 20A is similar, and functionally analogous to, the internal configuration of the first embodiment of the closure 20 described above with reference to FIGS. 8-13.

Both closures 20 and 20A function in the same manner for closing a container and for being open to accommodate pouring of the container contents through the opened closure.

Advantageous features of both closures 20 and 20A will next be described with reference to FIGS. 1-13 illustrating the first embodiment of the closure 20. In particular, when the closure 20 is opened (FIGS. 8 and 10), a user can readily pour the contents from the container (not shown) out through the closure 20. With reference to FIG. 10, the closure 20 may be characterized as having a typical or normal pour orientation along the closure central axis line A. With reference to FIG. 10, a user typically would initially hold the container oriented generally vertically (relative to the force of gravity) with the opened closure 20 at the top of the container. The user would then begin to tilt the container (with the opened closure 20 attached thereto) in alignment with the closure central axis line A so as to cause the front of the closure body 30 (along with its pour spout lip 76) to move downwardly while the rear of the closure body 30 and the opened lid 32 would remain higher than the spout lip 76. A sufficiently steep tilt will cause the contents from the container to flow out through at least the center portion of the curved pour aperture 50. Ambient atmospheric air would enter the vent apertures 60 to provide appropriate in-venting so as to assist in emptying the contents from the container through the opened closure 20.

The curved configuration of the pour aperture 50 and the arrangement of the vent apertures (60), especially the side-by-side arrangement of the spaced-apart dual vent apertures 60, facilitate smooth pouring. The contents of the container can relatively easily be poured out with a generally consistent flow and ease of use regardless of the fill level in the container. The vent aperture vent tubes 62 accommodate the return, or in-venting, of ambient atmospheric air into the container and past the outflowing contents.

The configuration and arrangement of the pour aperture 50 and vent apertures 60 also minimizes undesirable “glugging” that can be experienced with some conventional closures wherein the flow of the contents out of a conventional closure is temporarily and periodically interrupted by in-flowing ambient atmospheric air.

Owing to the shape of the curved pour aperture 50, the user need not maintain the tilted orientation and flow in precise alignment with the closure body central axis line A. If the user inadvertently rotates the container with the opened closure 20 somewhat about a longitudinal axis that is perpendicular to the closure body central axis line A, then more of the contents will flow out of the “higher” side of the arcuate aperture 50 than the other (“lower”) side. That is, there may be more flow out of the portion of the pour aperture 50 defined between the central axis A and one end 52 of the pour aperture 50 than out of the portion of the pour aperture 50 defined between the central axis A and the other end 52 of the pour aperture 50. At the same time, this “off center” pouring will still permit in-venting of ambient atmospheric air, especially through the vent aperture 60 that is located somewhat higher than the other vent aperture 60.

The closure 20 performs especially well when used for pouring liquids having viscosities similar to that of some kinds of soy sauce. In the preferred embodiment illustrated in FIG. 10, each vent aperture 60 is relatively small so that they can prevent or inhibit undesirable flow of the contents out through the vent apertures 60 but can still accommodate in-venting of the ambient atmospheric air.

The oval-shaped pour spout 70 which surrounds both the pour orifice 50 and vent apertures 60 provides a good flow “cutoff” at the spout lip 76 (FIG. 11) when the container and opened closure 20 are tilted back toward an upright orientation, and the spout 70 accommodates effective drainback of contents within the spout 70 back down through the pour aperture 50 and into the container.

With reference to FIG. 11, the presently preferred embodiment of the closure 20 includes two vent apertures 60, although according to one aspect of the invention only one aperture 60 could be provided for some fluid pouring applications, and more than two apertures 60 could be provided for other applications.

Further, in the preferred embodiment, especially when intended for use with a flowable substance having the viscosity of some types of conventional soy sauce, it has been discovered that very effective venting action occurs when (a) there are two vent apertures 60, (b) each vent aperture 60 (including its vent tube 62) defines a cylindrical vent flow path having substantially the same uniform cross-sectional diameter of about 3.3 millimeters, and (c) each vent tube 62 extends downwardly to a location that provides a vent path length of 6.1 millimeters as measured from the top of the opening of the vent aperture 60 at the top surface of the deck 40 down to the bottom end of the vent tube 62.

The venting action has been found to be particularly good, especially with liquids having a viscosity of some types of conventional soy sauce, when the ratio of the vent path length (from the top of the vent aperture 60 to the bottom of the vent tube 62) to the diameter of the internal circular, uniform cross section flow area of the vent flow path is within a range of about 1.5 to about 2.1, and is preferably about 1.8.

Although in the preferred embodiment illustrated in FIGS. 1-13, each vent aperture 60 is circular and each vent aperture 60 has the same diameter, it will be appreciated that in some applications the diameter of each vent aperture 60 need not be identical.

Further, although the presently most preferred form of the internal flow area of each vent aperture 60 and its vent tube 62 is circular, other noncircular configurations are contemplated (such as, for example, oval, elliptical, triangular, etc.).

In some pouring applications, there could be a variation or non-uniformity of the internal vent flow path cross-sectional flow area along the length or height of the flow path. However, in the presently preferred embodiment illustrated in FIGS. 1-13, each vent aperture 60 (which is defined in part by the associated vent tube 62) has a substantially uniform (i.e., substantially constant) cross-sectional flow area of 8.9 square millimeters along the length of the vent flow path (i.e., along the height of the vent aperture 60, including along the height of the vent aperture's vent tube 62). The vent flow path substantially constant cross section may be regarded as including, if desired, a slight taper or draft to facilitate release of the closure from a mold. In the presently preferred embodiment illustrated in FIG. 11, the ratio of the vent path substantially uniform cross-sectional flow area to the vent path length (from the top of the vent aperture 60 to the bottom of the vent tube 62) is within the range of about 1.0 to about 2.0, and is preferably about 1.5.

It will be readily observed from the foregoing detailed description of the invention and from the illustrations thereof that numerous other variations and modifications may be effected without departing from the true spirit and scope of the novel concepts or principles of this invention.

What is claimed is:

1. A closure (20, 20A) for a container that has an opening to the container interior wherein contents may be stored, said closure (20, 20A) comprising:
(A) a body (30, 30A) that is either (a) a separate structure for being attached to said container at said opening, or (b) a structure formed as a unitary portion of said container at said opening, and wherein
said closure body (30, 30A) has a deck (40) defining (i) at least one pour aperture (50) that can communicate with said container opening and that can accommodate pouring out of the contents through said at least one pour aperture (50) wherein said at least one pour aperture (50) has a curved configuration extending laterally on each side of a central axis line (A) that bisects said closure body (30), and (ii) at least one vent aperture (60) that can communicate with said container opening and that can accommodate the in-venting of ambient atmosphere through said at least one vent aperture (60) into said container, and
said closure body (30, 30A) has a pour spout (70) projecting outwardly from said deck (40) and extending at least partway around said at least one pour aperture (50); and
(B) a lid (32, 32A) for accommodating movement relative to said closure body (30, 30A) between (a) a closed position sealing against said closure body (30, 30A) to prevent flow of the contents outwardly of said closure body (30, 30A), and (b) an open position permitting flow of the contents outwardly of said closure body (30, 30A);
wherein said closure (20, 20A) is characterized in that
said at least one vent aperture (60)
(i) has a cross-sectional flow area as measured at said deck (40); and
(ii) is further defined by a vent tube (62) which projects downwardly from said deck (40) to define a vent path length from the top of said one vent aperture (60) to the bottom of said vent tube (62) wherein the ratio of said path length to said cross-sectional flow area is between about 1.0 and 2.0.

2. The closure (20, 20A) in accordance with claim 1 in which said ratio is about 1.5.

3. The closure (20, 20A) in accordance with claim 1 in which
said cross-sectional flow area of said at least one vent aperture (60) is substantially uniform along said vent path length from the top of said at least one vent aperture (60) to the bottom of said vent tube (62).

4. The closure (20, 20A) in accordance with claim 1 in which
said vent path length is about 6.1 millimeters; and
said at least one vent aperture (60) has a circular cross section with a substantially uniform diameter of about 3.3 millimeters along said vent path length.

5. The closure (20, 20A) in accordance with claim 1 in which
said closure (20, 20A) includes a hinge (36) connecting said closure body (30) and lid (32);
said closure body central axis line (A) bisects said closure body (30), hinge (36), and lid (32);
there are two of said vent apertures (60);
each said vent aperture (60) has a circular, substantially uniform cross section along said vent path length; and
the diameter of each said vent aperture (60) is greater than the width of said at least one pour aperture (50) wherein the width of said at least one pour aperture (50) is measured along said closure body central axis line (A).

6. The closure (20, 20A) in accordance with claim 1 in which said at least one vent aperture (60) has a substantially constant circular cross section along said vent path length and is spaced away from the nearest portion of said at least one pour aperture (50) by an amount that is greater than the diameter of said at least one vent aperture (60).

7. The closure (20, 20A) in accordance with claim 1 in which
said at least one vent aperture (60) has circular cross section along said vent path length; and
said vent tube (62) extends below said deck (40) by a distance which is greater than the diameter of the said circular cross section as measured at the top of said at least one vent aperture (60).

8. The closure (20; 20A) in accordance with claim 1 in which
said closure body deck 40 defines two of said at least one vent apertures (60) which each (1) has a circular cross section along said vent path length, (2) has the same diameter as measured at the top of each of said vent aperture (60), (3) is spaced apart from the other said vent aperture (60) by a distance that is less than the said vent aperture diameter, (4) is further defined by said vent tube (62).

9. The closure (20, 20A) in accordance with claim 1 in which
said closure (20, 20A) includes a hinge (36) connecting said closure body (30) and lid (32);
said closure body central axis line (A) bisects said closure body (30), hinge (36), and lid (32);
said at least one pour aperture (50) is the sole pour aperture (50);
there are two of said vent apertures (60);
each said vent aperture (60) has a circular, substantially uniform cross section along said vent path length from the top of said vent aperture (60) to the bottom of said vent tube (62);
the diameter of each said vent aperture (60) is greater than the width of said pour aperture (5Q) wherein the width of said pour aperture (50) is measured along said closure body central axis line (A);
said pour aperture (50)
(i) has a generally constant width over a major portion of its length and has arcuate ends (52);
(ii) is defined at least in part by two concentric circular arcs that are spaced apart to define said constant width of said pour aperture (50);
(iii) extends laterally on each side beyond said closure body central axis line (A) for a distance which is greater than the constant width of said pour aperture (50);
(iv) extends along a circular arc that is greater than 90 degrees in total arc length as measured from one end (52) of said pour aperture (50) on one side of said closure body central axis line (A) to the other end (52) of said pour aperture (50) on the other side of said closure body central axis line (A);
said vent apertures (60) are spaced equidistantly from, and are on opposite sides of, said closure body central axis line (A);
said vent apertures (60) are located with their centers on a straight line that is perpendicular to said closure body central axis line (A);
said pour aperture (50) extends to a location further away from said closure body central axis line (A) than does any part of either of said two vent apertures (60);
each said vent aperture (60) is spaced away from the nearest portion of said pour aperture (50) by an amount that is greater than said vent aperture diameter;
each said vent tube (62) is cylindrical and projects downwardly from said deck (40) a distance below said, deck (40) which is greater than said vent aperture diameter;
said closure body pour spout (0.70) extends completely around said pour aperture (50) and said vent apertures (60); and
said lid (32) includes a spud (94) for being received inside of, and sealingly engaged with, said spout (70) when said lid (32) is closed.
